(19) United States
(12) Patent Application Publication
(10) Pub. No.: US 2015/0220733 A1
(43) Pub. Date: Aug. 6, 2015

(54) APPARATUS AND METHOD FOR DETECTING A MALICIOUS CODE BASED ON COLLECTING EVENT INFORMATION

(71) Applicant: Electronics and Telecommunications Research Institute, Daejeon (KR)

(72) Inventors: Dae-Sung MOON, Daejeon (KR); Ik-Kyun KIM, Daejeon (KR); Hyun-Sook CHO, Daejeon (KR)

(21) Appl. No.: 14/603,241

(22) Filed: Jan. 22, 2015

(30) Foreign Application Priority Data
Feb. 3, 2014 (KR) 10-2014-0012280

(51) Int. Cl. G06F 21/56

(52) U.S. Cl. CPC G06F 21/56

(57) ABSTRACT

The apparatus for detecting a malicious code comprises a feature factor collecting module collecting information of feature factor events from a computing device based on the defined feature factors, a feature factor specification module converting the collected information of feature factor events to feature factor specification data in the form available on the analysis, and a malicious code detection module analyzing if a malicious code is or not by using the specification data.

### CROSS REFERENCE TO RELATED APPLICATION

This application claims the benefit of Korean Patent Application No. 10-2014-0012280, filed on Feb. 3, 2014, entitled “Apparatus and method for detecting a malicious code based on collected event information”, which is hereby incorporated by reference in its entirety into this application.

### BACKGROUND OF THE INVENTION

1. Technical Field

The present invention relates to an apparatus and method for detecting a process that executes a malicious code and more particularly, to an apparatus and method for detecting a malicious code which collects various event information from a user's computing device, reconstructs all activities from the start point to the end point of each process corresponding to the collected unit events, and detects if any malicious code is by each process or by each file based on the collected event information.

2. Description of the Related Art

A representative conventional malicious code detection and processing technology is a binary pattern-based malicious code detection technology which determines a file or process as a malicious code when a predefined binary pattern exists in the process or file which is required for malicious code inspection. Whenever a malicious code is detected, a specific binary pattern of the detected malicious code is registered to manage binary pattern data of malicious codes. Thus, the malicious code detection based on binary patterns shows a high detection rate and ensures fast detection time for the malicious codes of which binary patterns are managed and present. However, detection for unknown and/or variant malicious codes is not possible.

There is a behavior-based detection of malicious codes in addition to the binary pattern based detection of malicious codes. The behavior-based detection of malicious codes first defines behavior rules and then determines as a malicious code when any file or process corresponds to the rules. The behavior-based detection of malicious codes collects relating information on a user's PC or network for the application of the predefined rules. Thus, whenever a new rule is created, additional relating information should be collected. In addition, any correlation between running processes or stored files cannot be determined. Therefore, there is demand to develop data collection methods to detect even unknown and variant malicious codes and detect any malicious code based on the collected data.

### SUMMARY OF THE INVENTION

An object of the present invention is to collect various event information obtainable from a user's computing device in order to detect a malicious code and then detect a malicious code by processes or files based on reconstructed data.

Another object of the present invention is to apply data reconstructed by processes or files to a variety of malicious code detection methods by collecting the data regardless of malicious code detection methods.

According to an embodiment of the present invention, there is provided an apparatus for detecting a malicious code using collected event information. The apparatus for detecting a malicious code comprises a feature factor collecting module collecting information of feature factor events from a computing device based on the defined feature factors; a feature factor specification module converting the collected information of feature factor events into feature factor specification data in the form available on the analysis; and a malicious code detection module analyzing if a malicious code is or not by using the specification data.

The defined feature factor comprises information related to a computer process, information related to a file system, and information related to a registry available to detect a malicious code.

The feature factor collecting module collects, when an event corresponding to the defined feature factor occurs, information relating to the feature factor event.

The information of the feature factor event comprises host ID, user ID (login ID), collecting time, operating system, process name, process ID, feature factor ID, and additional information relating to the feature factor, etc.

The feature factor specification module reconstructs the collected information of the feature factor event into feature factor specification data by processes.

The feature factor specification module updates the information of the process in which the feature factor event is occurred and also updating the information of the parent process of the process in which the event is occurred.

The feature factor specification module reconstructs by executable files based on the feature factor specification data reconstructed by processes.

The feature factor specification data comprises specification representing the number of occurrences of the feature factor events.

The malicious code detection module determines if the updated executable process or file is a malicious code or not based on the specification data.

According to another embodiment of the present invention, there is provided a method for detecting a malicious code. The method for detecting a malicious code comprises: feature factor defining to define features, that may occur in a computing device, to detect malicious codes; feature factor event collecting to collect information of feature factor events from the computing device based on the defined feature factors; feature factor specification to convert the collected information of feature factor events into feature factor specification data in the form available on the analysis; and malicious code detecting to analyze if a malicious code is or not by using the specification data.

The defined feature factor comprises information related to a computer process, information related to a file system, and information related to a registry, etc. available to detect a malicious code.

The feature factor event collecting comprises collecting, when an event corresponding to the defined feature factor occurs in a system, information relating to the feature factor event.

The feature factor event information comprises host ID, user ID, collecting time, operating system, process name, process ID, feature factor ID, and additional information relating to the feature factor, etc.

The feature factor specification comprises reconstructing the collected information of the feature factor event into feature factor specification data by processes.

The feature factor specification comprises updating the information of the process in which the feature factor event is occurred and also updating the information of the parent process of the process in which the event is occurred.

The feature factor specification comprises reconstructing by executable files based on the feature factor specification data reconstructed by processes.

The feature factor specification comprises specification representing the number of occurrences of the feature factor events.

The malicious code detecting comprises determining if the updated executable process or file is a malicious code or not based on the specification data.

According to the present invention, the malicious code detection can be applied to any method for detecting a malicious code since various event information obtainable from a user's computing device is first collected to detect a malicious code and the collected events are reconstructed for all activities from the start point to the end point of each process to represent data.

Furthermore, the apparatus and method for detecting a malicious code of the present invention can detect unknown and/or variant malicious codes since various event information is collected from a user's computing device regardless of kinds of malicious codes.

### BRIEF DESCRIPTION OF DRAWINGS

FIG. 1 is a configuration view illustrating an apparatus for detecting a malicious code in a computing system according to an embodiment of the present invention.

FIG. 2 is a flowchart illustrating a method for detecting a malicious code according to an embodiment of the present invention.

FIG. 3 illustrates an example of a feature factor event list defined according to an embodiment of the present invention.

FIG. 4 illustrates an example of information collected in chronological order of feature factor events in the step of collecting feature factor events according to an embodiment of the present invention.

FIG. 5 illustrates another example of information collected in chronological order of feature factor events in the step of collecting feature factor events according to an embodiment of the present invention.

FIG. 6 illustrates an example of a feature factor specification list defined according to an embodiment of the present invention.

FIG. 7 is a flowchart illustrating a feature factor specification process for reconstructing the collected feature factor result by processes according to an embodiment of the present invention.

FIG. 8 illustrates a feature factor specification process for reconstructing the collected feature factor result of FIG. 4 by processes according to an embodiment of the present invention.

FIG. 9 illustrates a result of the specification process after reconstruction of feature factor collecting result by processes.

FIG. 10 illustrates exemplary embodiments of the present invention implemented in a computer system.

### DESCRIPTION OF THE EXEMPLARY EMBODIMENTS

While the present invention has been described with reference to particular embodiments, it is to be appreciated that various changes and modifications may be made by those skilled in the art without departing from the spirit and scope of the present invention, as defined by the appended claims and their equivalents.

Throughout the description of the present invention, when describing a certain technology is determined to evade the point of the present invention, the pertinent detailed description will be omitted.

Unless clearly used otherwise, expressions in the singular number used in the present invention include a plural meaning.

Module, unit, interface and the like among the terms used in the description means general objects relating to a computer such as hardware, software and a combination thereof.

FIG. 1 is a configuration view illustrating an apparatus for detecting a malicious code in a computing system according to an embodiment of the present invention.

As shown in FIG. 1, an apparatus for detecting a malicious code 100 comprises a feature factor collecting module 101, a feature factor specification module 102, a malicious code detection module 103, a feature factor information storing module 104, a visualizing module 105, and a control module 106.

The feature factor collecting module 101 collects, whenever various feature factor events defined in a computing device occur, information relating thereto in order to detect a malicious code. Here, the feature factor event includes information relating to a process of the user's computing device, information related to a file system, information related to a registry and the like. The feature factor can be added if necessary. The feature factor-based feature factor collecting module collects, whenever a feature factor event occurs, information relating thereto. When a feature factor event occurs, information to be collected includes host ID, user ID, collecting time, operating system, process name, process ID, feature factor ID, additional information relating to the feature factor and the like. Additional information for the corresponding feature factor can vary with feature factors. When an event that the process generates another process occurs, information may include an ID of the child process.

The feature factor specification module 102 is a module to reconstruct each of the feature factor events collected by the feature factor collecting module 101 by processes. The feature factor specification module 102 does not define unit event, but reconstructs all activities from the start point to the end point of processes by a specific process to provide information possible to determine if the feature process is a normal code or a malicious code by providing feature factor specification. Furthermore, the feature factor specification module can be data-mated by integrating by executable files which generate the process.

Whenever the process specification information, which is reconstructed by the feature factor specification module 102 whenever an event occurs, is updated, the malicious code detection module 103 determines if it is a normal code or a malicious code with the inputted process information of the updated feature factor events. The malicious code detection module 103 may determine a malicious code by being applied to a model generated by a mining algorithm or to behavior-based rules for the detection of malicious codes.

The feature factor information storing module 104 stores the collected event information, feature factor specification data reconstructed by processes or executable files, and information about malicious codes.

The visualizing module 105 visualizes information to be provided to a user. The visualizing module 105 visualizes and outputs the information relating to the events collected through the feature factor collecting module 101, the feature factor specification information reconstructed by processes or executable files by the feature factor specification module 102, the malicious code information according to the malicious code detection module 103 for a user to recognize easily. The visualizing module 105 may include graphic user interface (GUI) for a user to understand the information relating to the events, the feature factor specification information, and the malicious code information.

The control module 106 may control the overall operations and workings of the apparatus for detecting a malicious code 100.

A method for detecting a malicious code according to an embodiment of the present invention to protect a computing device against a malicious attack will be described hereinafter.

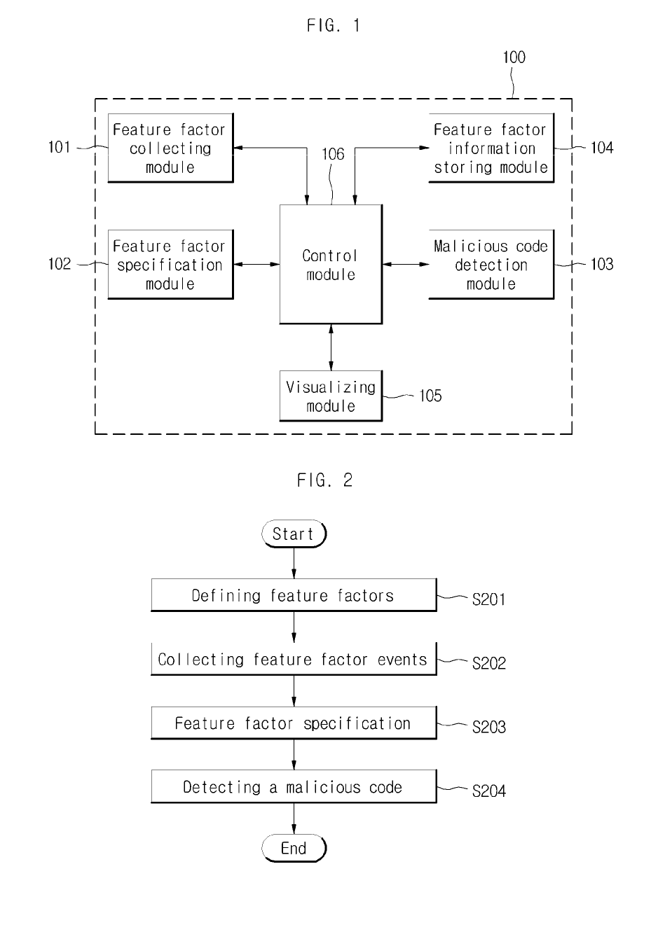

FIG. 2 is a flowchart illustrating a method for detecting a malicious code according to an embodiment of the present invention.

The apparatus for detecting a malicious code 100 detects a malicious code by the method comprising feature factor defining to define features that may occur in a computing device to detect malicious codes in S201; feature factor event collecting to collect information of feature factor events from the computing device based on the defined feature factors in S202; feature factor specification to convert the collected information of feature factor events into feature factor specification data in the form available on the analysis in S203; and malicious code detecting to analyze if a malicious code is or not by using the specification data in S204.

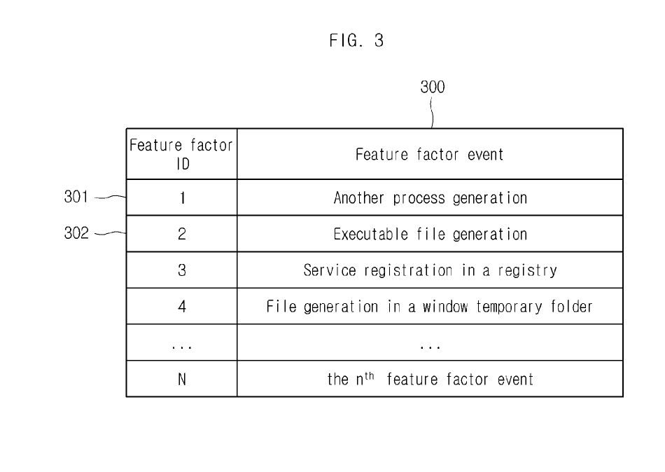

As shown in FIG. 3, a variety of event information which can be obtained from a computing device are defined to detect a malicious code in the step of defining feature factors of S201. The variety of event information of the computing device comprises information relating to a process of the user's computing device, information related to a file system, information related to a registry and the like.

FIG. 3 shows an example of a list of the defined feature factor events 300 and an additional feature factor can be defined if necessary. For example, the feature factor ID No. 1 event 301 means that a running process generates another process and the feature factor ID No. 2 event 302 means that the running process generates an executable file. N is the number of defined feature factors.

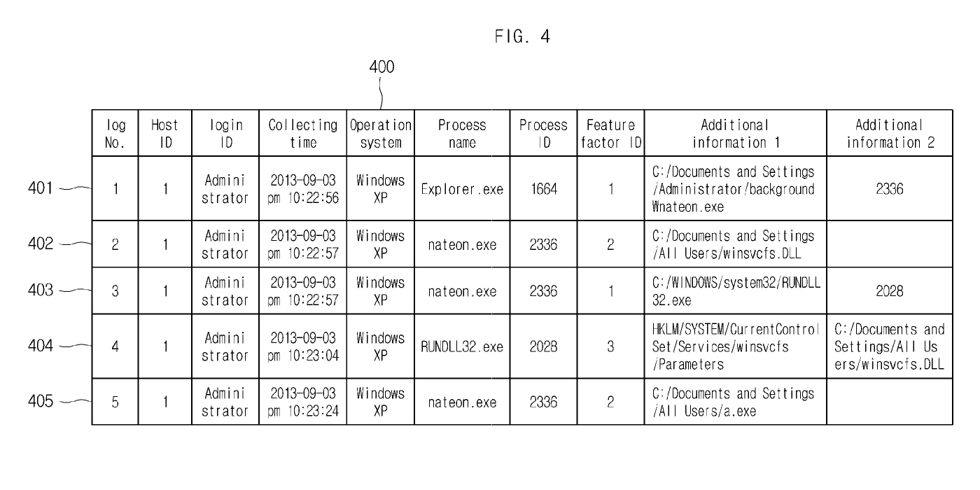

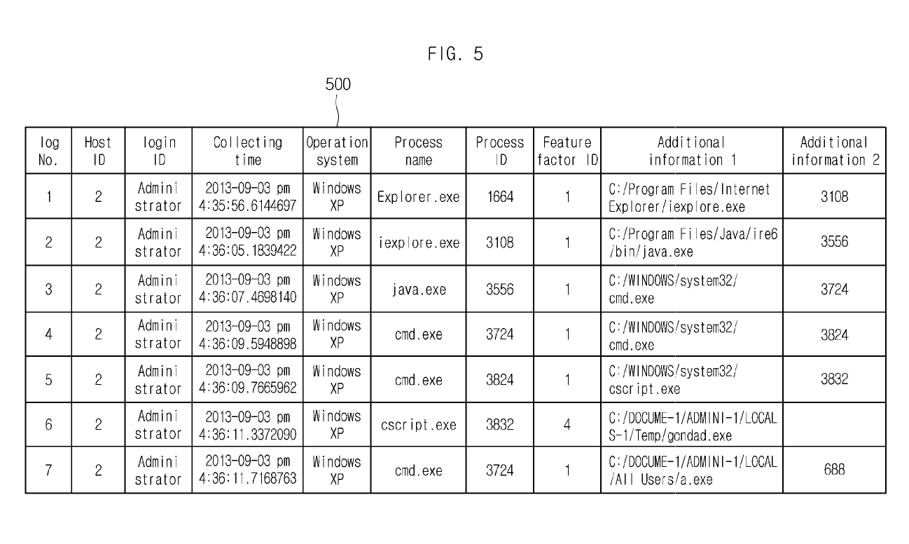

The step of collecting feature factors comprises collecting information in chronological order whenever a feature factor event defined from a computing device through the feature factor collecting module 101 occurs, based on the defined feature factors as shown in FIG. 4 or FIG. 5 and storing the result in feature factor information storing module 104.

As shown in FIG. 4 or FIG. 5, the information to be collected when a feature factor event occurs includes host ID, user (log-in) ID, collecting time, operating system, process name, process ID, feature factor ID, additional information relating to the feature factor and the like. Additional information depending on the feature factors can vary with feature factor IDs and when an event that another process is generated occurs, it may include an ID of a child process.

The step of feature factor specification of S203 comprises reconstructing each of the feature factor events collected in the step of collecting feature factors by processes or by executable files.

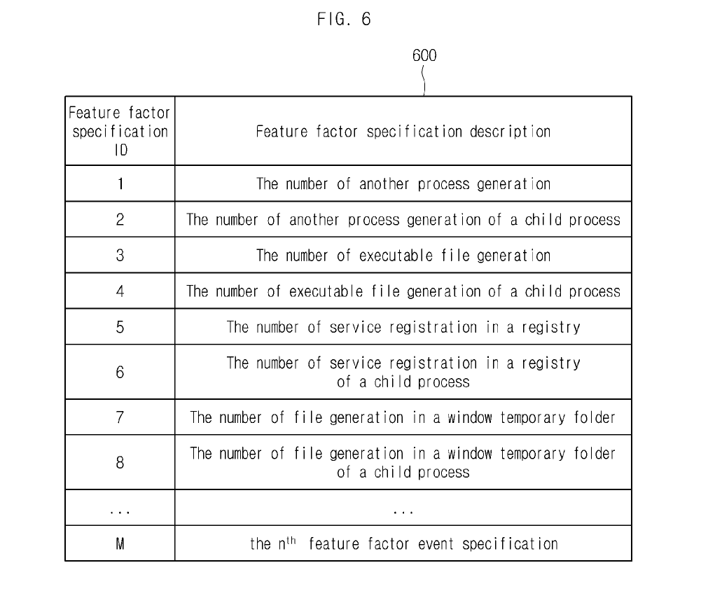

Since it is not easy to detect if a feature process is normal or malicious with unit event collected in the step of collecting feature factors of S202, it can facilitate the detection of a malicious code by utilizing feature factor specification which is the result of reconstruction of all activity from the start point to the end point of a feature process. A feature factor specification list as shown in FIG. 6 uses feature factor definition information of FIG. 3 and can be additionally defined. According to FIG. 6, the feature factor specification list is represented by the number of occurrences of the feature factor events and M is the number of the feature factor specifications.

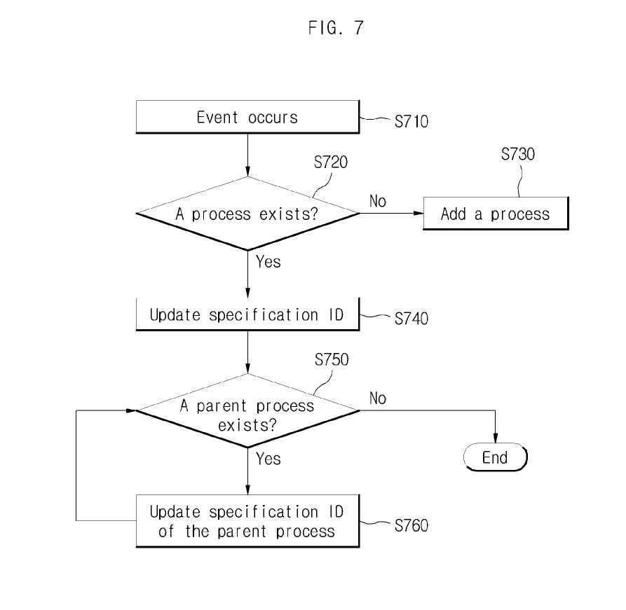

FIG. 7 is a flowchart illustrating a feature factor specification process for reconstructing the collected feature factor result by processes according to an embodiment of the present invention.

As shown in FIG. 7, when a feature factor event occurs and a feature factor event is collected in S710, it determines if a process corresponding to the feature factor specification list exists in S720. When a process corresponding to the feature factor specification list exists, a feature factor specification ID value is updated in S740. On the other hands, when a process does not exist, the process is added in the feature factor specification list in S730 and then a feature factor specification ID value gets updated in S740. In addition, when a parent process of the corresponding process exists, a feature factor specification ID value of the parent process is continuously updated till the parent process does not exist in S760.

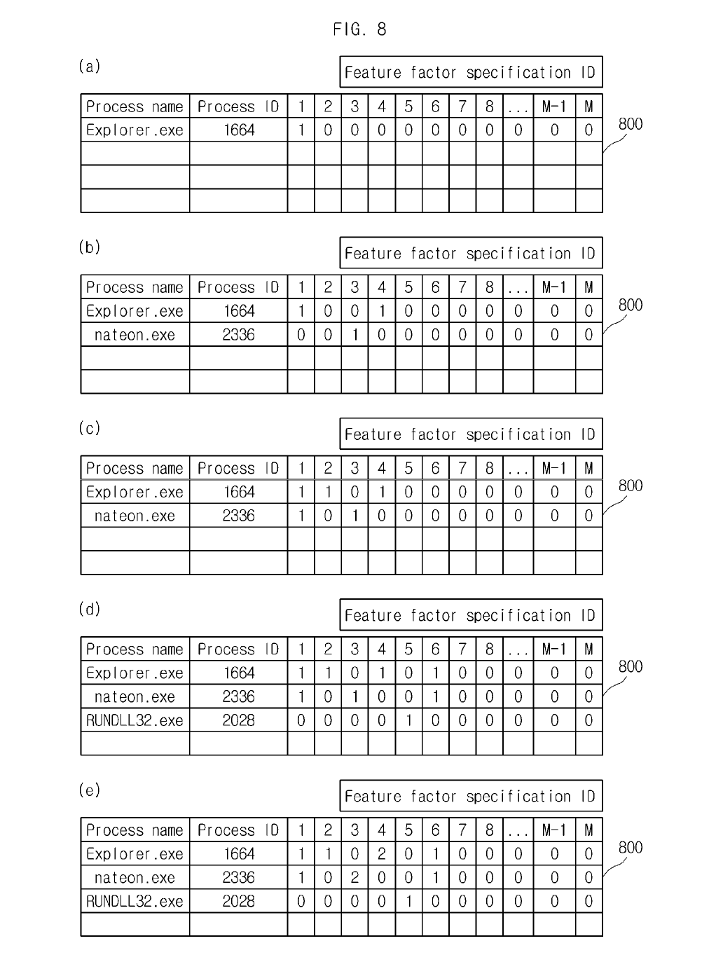

FIG. 8 illustrates a feature factor specification process for reconstructing the collected feature factor result of FIG. 4 by processes according to an embodiment of the present invention.

The feature factor specification information in the step of feature factor specification includes a process name, a process ID, a feature factor specification ID value and the like. The feature factor specification information is updated based on the process ID in chronological order of log numbers for the collected events in FIG. 4.

FIG. 8(a) is the feature factor specification information of 401 of the log No. 1 in FIG. 4. When an event that the process of Explorer.exe (PID:1664) generates another process (PID:2336) occurs, it corresponds to No. 1 of the feature factor specification ID of the process (PID:1664) and the value of No. 1 of the feature factor specification ID of the process is increased by 1. No. 1 of the feature factor specification ID means the number of another process generations as shown in FIG. 6.

FIG. 8(b) is the feature factor specification information of 402 of the log No. 2 in FIG. 4. when an event that the process of nateon.exe (PID:2336) generates an executable file occurs, it corresponds to the feature factor specification ID No. 3 of the process (PID:2336) and the feature factor specification ID No. 3 is increased by 1. No. 3 of the feature factor specification ID means the number of executable file generations as in FIG. 6. In case of the process (PID:2336), since the parent process (PID:1664) exists and in the view of the parent process (PID:1664), an event that the child process generates an executable file occurs, it corresponds to No. 4 of the feature factor specification ID and thus the value of the feature factor specification ID No. 4 of the parent process (PID:1664) is increased by 1. The feature factor specification ID NO. 4 means the number of executable file generations of the child process as shown in FIG. 6.

FIG. 8(c) is the feature factor specification information of 403 of the log No. 3 in FIG. 4. When an event that the process of nateon.exe (PID:2336) generates another process (PID:2028) occurs, it corresponds to the feature factor specification ID No. 1 of the process (PID:2336) and the value of the feature factor specification ID No. 1 is increased by 1. The feature factor specification ID No. 1 means the number of another process generations as in FIG. 6. In the view of the parent process (PID:1664), since an event that the child process generates another process, it corresponds to the feature factor specification ID No. 2 and the value of the feature factor specification ID No. 2 of the parent process (PID:1664) is increased by 1. The feature factor specification ID No. 2 means the number of another process generation of the child process.

FIG. 8(d) is the feature factor specification information of 404 of the log No. 4 in FIG. 4. When an event that RUNDLL32.exe (PID:2028) registers a service in a registry occurs, it corresponds to the feature factor specification ID No. 5 of the process (PID:2028) and thus the value of the feature factor specification ID No. 5 is increased by 1. The feature factor specification ID No. 5 means the number of service registrations to the registry as in FIG. 6. In the view of the parent processes (PID: 2336, PID:1664) of the process (PID:2028), when an event that the child process registers a service in the registry, it corresponds to the feature factor specification ID No. 6 and thus each value of the feature factor specification ID No. 6 of the parent processes (PID: 2336, PID:1664) is increased by 1. The feature factor specification ID No. 6 means the number of service registration to the registry of the child process.

FIG. 8(e) is the feature factor specification information of 405 of the log No. 5 in FIG. 4. When an event that the process of nateon.exe (PID:2336) generates an executable file occurs, it corresponds to the feature factor specification ID No. 3 of the process (PID:2336) and the value of the feature factor specification ID No. 3 is increased by 1 to result 2. In addition, the value of the feature factor specification ID No. 4 of the explorer.exe (PID:1664) which is the parent process of nateon.exe (PID:2336) is also increased by 1 to result 2. As described above, FIG. 8(e) is the result through the feature factor specification step sequentially from the first event of the collected feature factor events in FIG. 4 to log No. 5.

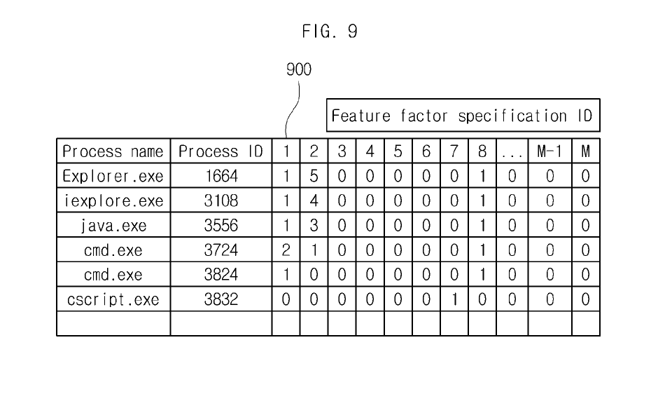

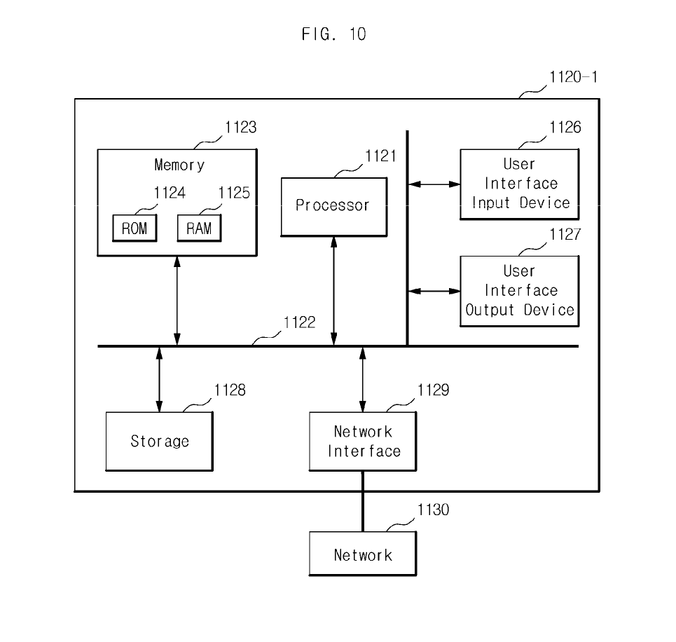

FIG. 9 is the result obtained by the same method through the feature factor specification step for the collected result in FIG. 5.

As in FIG. 8(e) and FIG. 9, all event information, which is generated by a particular process from the start to the end through the feature factor specification step along the course of feature event occurrence, can be data-mated.

As in FIG. 8(e) and FIG. 9, the result of the feature factor specification by processes can be data-mated by integrating by executable files which generate processes. Since the same process names in FIG. 8 and FIG. 9 are oriented from the same executable file, the feature factor specification information of process IDs having the same process name can be combined. For example, since there are no process IDs having the same process name in FIG. 8, executable files are also the same as in FIG. 8. However, when there are 2 process IDs (PID:3724, PID:3824) having the same process name of cmd.exe, the executable file cmd.exe combines the feature factor specification information of the process ID 3724 and that of the process ID 3824 to result the value of feature factor specification ID No. 1 of 3 and the value of the feature factor specification ID No. 2 of 1 and the value of the feature factor specification ID No. 8 of 2.

In the step of detecting a malicious code of S204 which analyzes if a malicious code is or not, whenever a feature factor event is collected, the feature factor specification list is updated and information of the processes of the updated feature factor event is inputted to the malicious code detection module 103 to determine if it is normal/malicious. The feature factor specification information of the present invention is applicable to various malicious code detection methods so that the malicious code detection module 103 can apply the feature factor specification information to a model generated by a mining algorithm such as SVM (support vector machine) and the like or a behavior-based rule in order to detect a malicious code.

When a new event is collected in the step of detecting a malicious code of S204, a process of transmitting the updated information to the malicious code detection module 103 will be only explained with FIG. 8(e).

FIG. 8(e) illustrates a case that 4 feature factor events are already collected and an event that the process of nateon.exe (PID:2336) generates an executable file as the 5^{th} feature factor event is occurring. Here, it corresponds to the feature factor specification ID No. 3 of the process (PID:2336) and thus the value of the feature factor specification ID No. 3 is increased by 1 to result 2 and the value of the feature factor specification ID No. 4 of the explorer.exe (PID:1664) which is the parent process of nateon.exe (PID:2336) is also increased by 1 to result 2. Here, since the feature factor specification information of 2 processes of nateon.exe (PID:2336) and explorer.exe (PID:1664) is only updated, the updated specification information of 2 processes is transmitted to the malicious code detection module to be detected if it is normal/malicious.

An embodiment of the present invention may be implemented in a computer system, e.g., as a computer readable medium. As shown in in FIG. 10, a computer system 1120-1 may include one or more of a processor 1121, a memory 1123, a user input device 1126, a user output device 1127, and a storage 1128, each of which communicates through a bus 1122. The computer system 1120-1 may also include a network interface 1129 that is coupled to a network 1130. The processor 1121 may be a central processing unit (CPU) or a semiconductor device that executes processing instructions stored in the memory 1123 and/or the storage 1128. The memory 1123 and the storage 1128 may include various forms of volatile or non-volatile storage media. For example, the memory may include a read-only memory (ROM) x1124 and a random access memory (RAM) 1125.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

The computer readable medium may include a program instruction, a data file and a data structure or a combination of one or more of these.

The program instruction recorded in the computer readable medium may be specially designed for the present invention or generally known in the art to be available for use. Examples of the computer readable recording medium include a hardware device constructed to store and execute a program instruction, for example, magnetic media such as hard disks, floppy disks, and magnetic tapes, optical media such as CD-ROMs, and DVDs, and magneto-optical media such as floptical disks, read-only memories (ROMs), random access memories (RAMs), and flash memories. In addition, the above described medium may be a transmission medium such as light including a carrier wave transmitting a signal specifying a program instruction and a data structure, a metal line and a wave guide. The program instruction may include a machine code made by a compiler, and a high-level language executable by a computer through an interpreter.

The above described hardware device may be constructed to operate as one or more software modules to perform the operation of the present invention, and vice versa.

While it has been described with reference to particular embodiments, it is to be appreciated that various changes and modifications may be made by those skilled in the art without departing from the spirit and scope of the embodiment herein, as defined by the appended claims and their equivalents. Accordingly, examples described herein are only for explanation and there is no intention to limit the invention. The scope of the present invention should be interpreted by the following claims and it should be interpreted that all spirits equivalent to the following claims fall with the scope of the present invention.

### DESCRIPTION OF REFERENCE NUMERALS

100: Apparatus for detecting a malicious code
101: Feature factor collecting module
102: Feature factor specification module
103: Malicious code detection module
104: Feature factor information storing module
105: Visualizing module
106: Control module
300: Feature factor event list
400, 500: Collected feature factor event information
600: Feature factor specification list
800, 900: Feature factor specification information by processes

What is claimed is:

1. An apparatus for detecting a malicious code comprising:
a feature factor collecting module collecting information of feature factor events from a computing device based on defined feature factors;
a feature factor specification module converting the collected information of feature factor events into feature factor specification data in the form available on the analysis; and
a malicious code detection module analyzing if a malicious code is or not by using the specification data.

2. The apparatus for detecting a malicious code of claim 1, wherein the defined feature factor comprises information related to a computer process, information related to a file system, and information related to a registry available to detect a malicious code.

3. The apparatus for detecting a malicious code of claim 1, wherein the feature factor collecting module collects, when an event corresponding to the defined feature factor occurs, information relating to the feature factor event.

4. The apparatus for detecting a malicious code of claim 3, wherein the information of the feature factor event comprises host ID, user ID, collecting time, operating system, process name, process ID, feature factor ID, and additional information relating to the feature factor.

5. The apparatus for detecting a malicious code of claim 1, wherein the feature factor specification module reconstructs the collected information of the feature factor event into feature factor specification data by processes.

6. The apparatus for detecting a malicious code of claim 5, wherein the feature factor specification module updates the information of the process in which the feature factor event is occurred and also updating the information of the parent process of the process in which the event is occurred.

7. The apparatus for detecting a malicious code of claim 5, wherein the feature factor specification module reconstructs by executable files based on the feature factor specification data reconstructed by processes.

8. The apparatus for detecting a malicious code of claim 5, wherein the feature factor specification data comprises specification representing the number of occurrences of the feature factor events.

9. The apparatus for detecting a malicious code of claim 1, wherein the malicious code detection module determines if the updated executable process or file is a malicious code or not based on the specification data.

10. A method for detecting a malicious code comprising:
feature factor defining to define features that may occur in a computing device to detect malicious codes;
feature factor event collecting to collect information of feature factor events from the computing device based on the defined feature factors;
feature factor specification to convert the collected information of feature factor events to feature factor specification data in the form available on the analysis; and
malicious code detecting to analyze if a malicious code is or not by using the specification data.

11. The method for detecting a malicious code of claim 10, wherein the defined feature factor comprises information related to a computer process, information related to a file system, and information related to a registry available to detect a malicious code.

12. The method for detecting a malicious code of claim 10, wherein the feature factor event collecting comprises collecting, when an event corresponding to the defined feature factor occurs in a system, and information relating to the feature factor event.

13. The method for detecting a malicious code of claim 10, wherein the feature factor event information comprises host ID, user ID, collecting time, operating system, process name, process ID, feature factor ID, and additional information relating to the feature factor.

14. The method for detecting a malicious code of claim 10, wherein the feature factor specification comprises reconstructing the collected information of the feature factor event into feature factor specification data by processes.

15. The method for detecting a malicious code of claim 14, wherein the feature factor specification comprises updating the information of the process in which the feature factor event is occurred and also updating the information of the parent process of the process in which the event is occurred.

16. The method for detecting a malicious code of claim 14, wherein the feature factor specification comprises reconstructing by executable files based on the feature factor specification data reconstructed by processes.

17. The method for detecting a malicious code of claim 14, wherein the feature factor specification comprises specification representing the number of occurrences of the feature factor events.

18. The method for detecting a malicious code of claim 10, wherein the malicious code detecting comprises determining if the updated executable process or file is a malicious code or not based on the specification data.
